(19) United States
(12) Patent Application Publication
(10) Pub. No.: US 2011/0205201 A1
(43) Pub. Date: Aug. 25, 2011

(54) MICROENCAPSULATED ELECTROPHORETIC PRICE DISPLAY SYSTEM

(75) Inventors: MARK ANDREW LORKOWSKI, TALLMADGE, OH (US); CHRIS SCOTT LORKOWSKI, AKRON, OH (US); JAMES MICHAEL LORKOWSKI, WAYNE, NJ (US)

(73) Assignee: LORKOWSKI TECHNOLOGIES LLC, TALLMADGE, OH (US)

(21) Appl. No.: 13/031,419

(22) Filed: Feb. 21, 2011

Related U.S. Application Data
(60) Provisional application No. 61/306,462, filed on Feb. 20, 2010.

(51) Int. Cl. G09G 5/00; G09G 3/34

(52) U.S. Cl. 345/207; 345/107

(57) ABSTRACT

An electronic product price display system for installation in a retail environment for displaying price and related information concerning retail consumer products price including at least one microencapsulated electrophoretic display label for displaying information about consumer products; a power system for powering the display labels, where the power system includes a photovoltaic cell coupled with a means for storing the power generated by the photovoltaic cell; an antenna for receiving RF signals and transmitting them to a microcontroller; a microcontroller for receiving RF communication signals and for converting the received signals into instructions to change the display labels; a programmable computer module for generating instructions for the labels; means for receiving said instructions from said computer and generating RF instruction signals; and means for removably affixing said labels to store shelving holding the consumer products.

### RELATED APPLICATIONS

The present invention claims the priority of provisional patent application Ser. No. 61/306,462 filed on Feb. 19, 2010, the disclosure of which is incorporated herein by reference.

### BACKGROUND OF THE INVENTION

The invention relates to price displays in a retail setting and, more specifically, electronic price labels (or EPLs).

The majority of price display systems in retail stores are currently paper based printed stickers due to their cost effectiveness and functionality. The stores must use costly employee time however to change the physical sticker to update a price. This also limits the number of price changes which can occur and the times at which they can occur. EPL systems have been invented to add the ability of price updates and save the cost of having employees update the prices by hand. The problem with current designs however, is that most systems are difficult and expensive to implement and often do not give full price adjustability at any time. Some systems require complicated data and power transmission methods that are difficult and costly to install. Other systems have issues with not being able to be updated at any given time and limit the system functionality and cost benefits. Some systems still require a worker to recharge or replace tags over time or to use a device near the tag to update it, defeating the benefits.

### BRIEF SUMMARY OF THE INVENTION

The present invention is directed to an electronic product price display system for installation in a retail environment for displaying price and related information concerning retail consumer products price including at least one microencapsulated electrophoretic display label for displaying information about consumer products; a power system for powering the display labels, where the power system includes a photovoltaic cell coupled with a means for storing the power generated by the photovoltaic cell; an antenna for receiving RF signals and transmitting them to a microcontroller; a microcontroller for receiving RF communication signals and for converting the received signals into instructions to change the display labels; a programmable computer module for generating instructions for the labels; means for receiving said instructions from said computer and generating RF instruction signals; and means for removably affixing said labels to store shelving holding the consumer products.

### BRIEF DESCRIPTION OF THE DRAWING

The foregoing and other features and advantages of the present invention will become apparent to those skilled in the art to which the present invention relates upon reading the following description with reference to the accompanying drawings, in which:

FIG. 1 is a perspective view of shelving, which would hold merchandise, showing the electronic price tags applied to the shelves;

FIG. 2 is a schematic view of the component parts of the display module;

FIG. 3 is top view of a microencapsulated electrophoretic display, in accordance with the present invention and applied to a clothing tag;

FIGS. 4A and 4B are a schematic (4A) of a microencapsulated electrophoretic shelf display and an example (4B) of the graphics for the display; and

FIG. 5 is a schematic view of a computer system for use in the present invention and showing a plurality of RF transceivers coupled with shelving showing the electronic tags of the present invention receiving signals from the computer system.

### DETAILED DESCRIPTION OF THE INVENTION

The present invention is directed to an electronic price tag which includes a microencapsulated electrophoretic display coupled with a microcontroller, a power system and antenna for receiving radio frequency (RF) signals. The system also includes a computer and RF transceiver, which provides a RF based network to update the price display.

A microencapsulated electrophoretic price display system lessens the power draw and dynamic display issues. Microencapsulated electrophoretic displays do not draw power when the display is not changing, but can be changed electronically. A microencapsulated electrophoretic display coupled with a microcontroller and operating on a RF based network allows a cheap, long lasting, stable and dynamic price display system for retail stores to optimize their pricing at will and for very low cost.

The display screen will preferably be a microencapsulated electrophoretic segmented display. This will be a bistable display such that the display remains after the power is removed from the display. Whatever is showing on the screen remains until the next time power is applied to the screen and the image is refreshed. The unique characteristics of the display allow it to continue to display the image without any power. If the solar cell is occluded and the tag goes without power, it will not change until it receives light. If the tag does not have light, the customer would not be able to see the price anyway. There will be a provision in the software to send out the price updates multiple times or possibly continuously to make sure the prices stay accurate or to indicate that there is currently no or inadequate display at a particular unit.

The display can be a seven or fourteen segment display, but other displays can be used. The multiple segments can change from black to white for displaying, for example, the item price and price per unit of measure as required by law in some states. But, the display can be a dot-matrix display as well. Currently, a segmented display is the least expensive and thus preferred, although either could work. Further, the display will preferably be a black and white display, but it also could be a color display. Suitable display screens are available from E Ink.

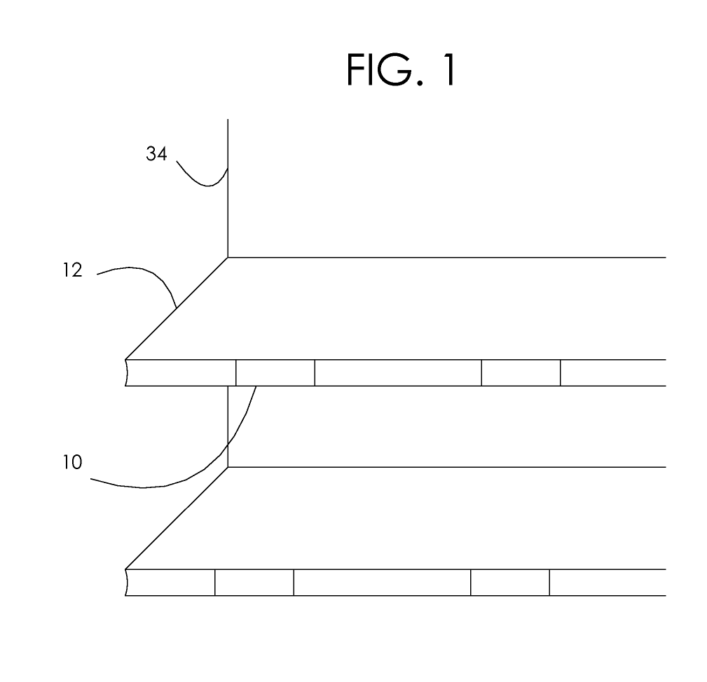

As seen in FIG. 1, the electronic display 10 is placed upon the end of shelving 12 having space for holding the consumer goods. This is the typical placement of pricing and other information concerning the particular consumer goods.

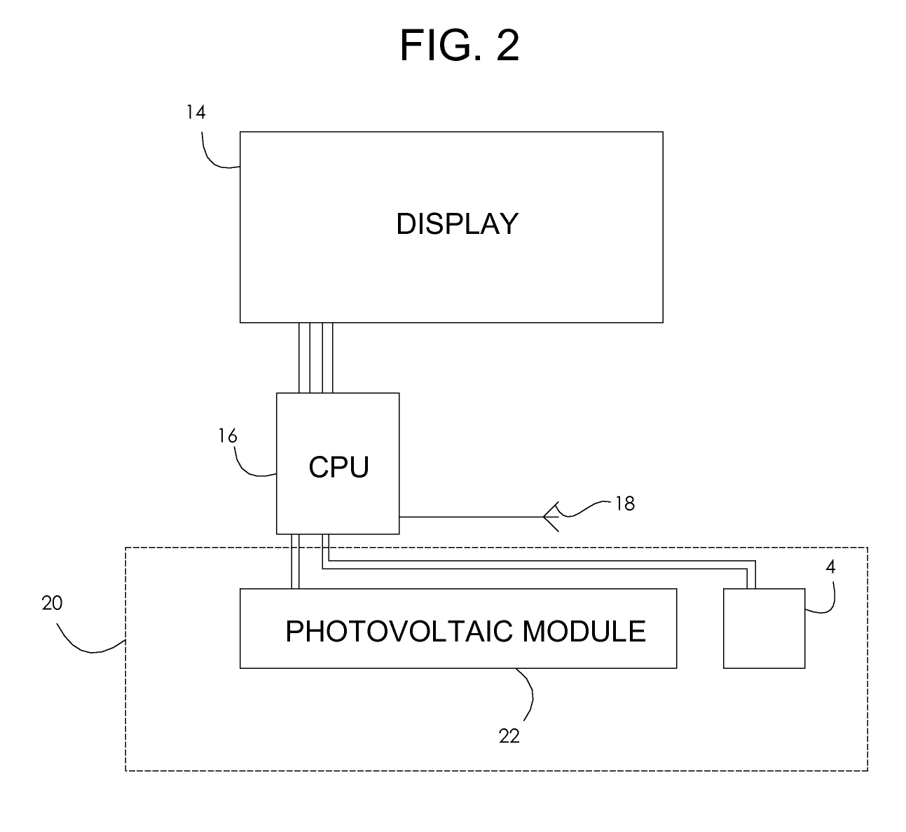

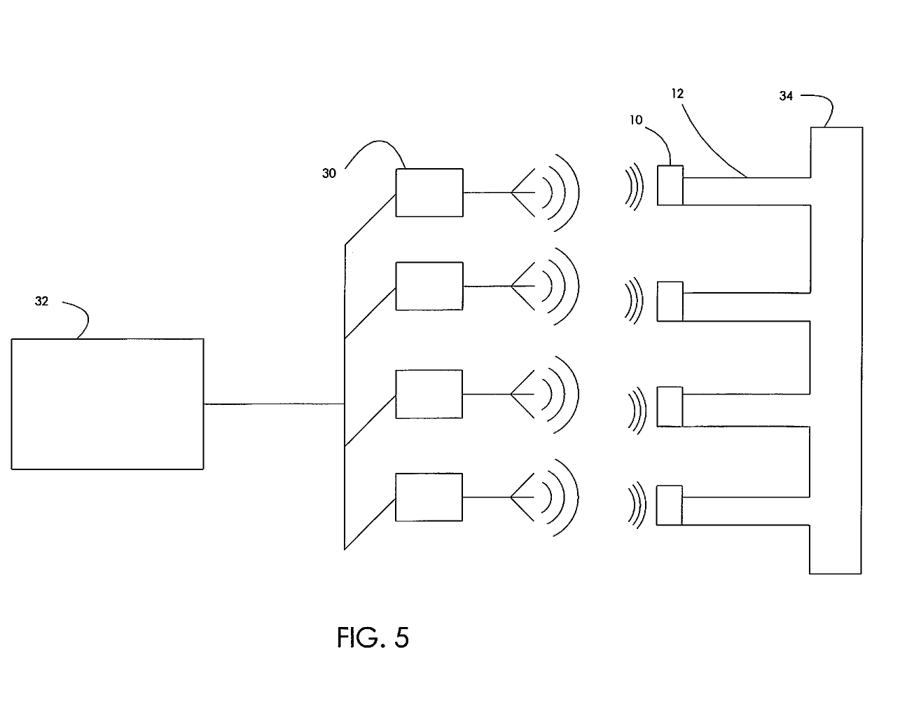

As seen in FIG. 2, the electronic display is made up from a combination of the display screen 14, a microcontroller 16, an antenna 18, and a power system 20. The power system will include a photovoltaic cell 22 (or solar cell) coupled with a capacitor 4. The photovoltaic cell 22 will generate electricity from the ambient lighting system in a store and power the capacitor 4 which in turn will provide the switching voltage to the display screen 14 to update the pricing information on the display screen. When the microcontroller 16 receives a signal from an RF transceiver 30 (shown in FIG. 5) via antenna 18, the microcontroller will direct the display screen to display the new information provided by the store computer 32.

The electronic display (or tag) is preferably a “passive” RF receiver only, in that it is not capable of two way communications. The communication may be routine when the store changes its weekly prices or may be responsive to changes in shopping patterns. For example, the stores computer may notice a trend and decide to change a price on an item or items. This can happen continuously and quickly, and may require updating all prices within a day if needed. To do so, the computer will send a signal to a RF transmitter somewhere in the store which will be broadcasting a unique tag ID number, a passcode and the price display data. The tag will be in a low power receiving state listening for their unique ID (similar to a car remote) and if the embedded ID and passcode are correct, it wakes up the driver chip in the microcontroller and changes the display.

The microcontroller is preferably a programmable microchip embedded in a flexible circuit board. The microcontroller is programmed to signal the display to show the appropriate product name, price, price per unit of the item, and other appropriate and required information. The microcontroller then goes back to a low power state. The microcontroller will have an integrated RF receiver, low power waiting mode and integrated display driver chip. The receiver chip is connected or embedded into the microcontroller. When the microcontroller reads the signal from the receiver, it takes the power from the capacitor which receives power from the solar cell, and outputs to the display driver chip. The display driver chip will then change the display. It is the trigger in the signal ID and passcode that wakes up the microcontroller and the display driver chip controls the discharge to the display. The solar cell will charge very small “charge pumps” which are capacitors for when the display is changing. These charge pumps can be 100 nF capacitors, which are preferred, but other charge pumps can be employed. The solar cell will also supply the power for the microcontroller and receiver. A small capacitor will be included for when the microcontroller wakes up from the low power state. The capacitor circuit will preferably run between 1.8V-12V, preferably on the lower end of the range, and will preferably be a 100 nF (nanoFarad) capacitor, but it can be in the range of 5 to 1000 nF, with 50-150 nF being further preferred. For example, the capacitor could be a smart card storage capacitor and such are available from Dialog Semiconductor and other companies.

Depending upon the type of photocell used, and the power consumption of the microcontroller during its higher, activated state, the “power system” may not need a separate capacitor, and may just need a photocell since the microcontroller may have an energy storage capability and thus functions as or like a capacitor. As noted above, the microcontroller when it is in a low powered state receives a signal, turns to a high powered state. When the microcontroller switches to a high powered state, it draws more power from the “power system”, the photocell or alternatively the capacitor provide the power for a very short time and then the microprocessor returns to the low powered state once the display has changed.

The antenna will preferably be a separate antenna, and such are commercially available, but the antenna could be a simple copper trace which is part of and placed on the flexible printed circuit board that hold the display, solar cell, and chips together. The flat copper trace can be placed on the flexible PCB (printed circuit board). The antenna is connected to the receiver chip.

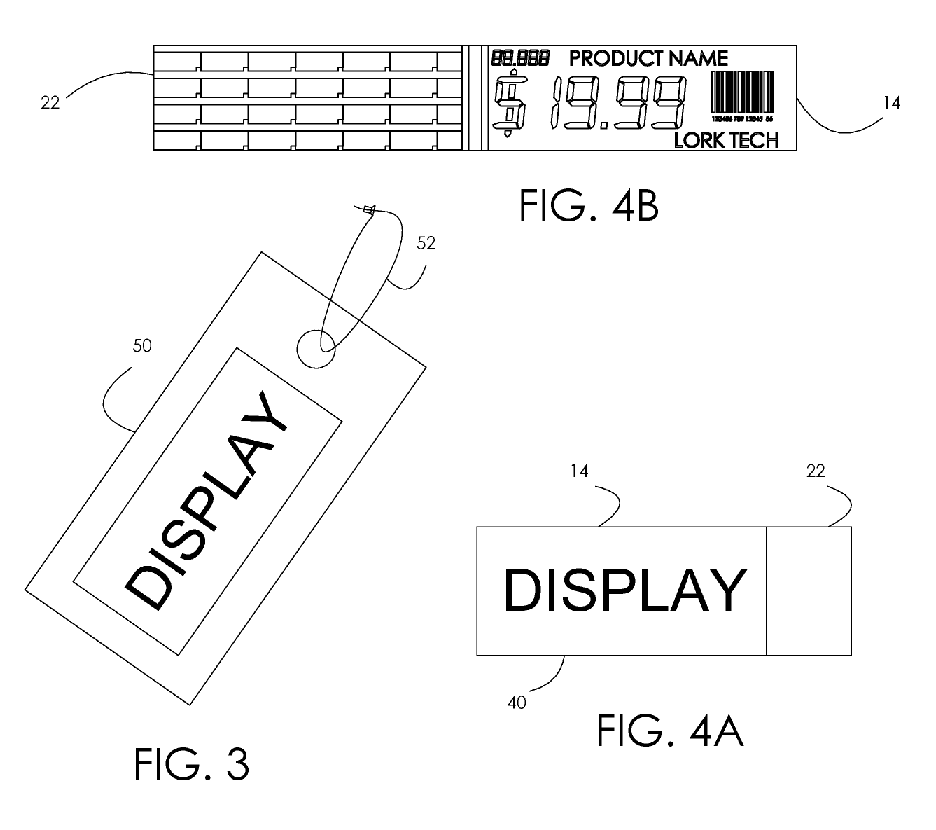

FIG. 3 illustrates an electronic display module which could be used for pricing clothing. This can be in the form of a retail clothing tag. The tag 50 will hang from the clothing via a typical quick tie 52.

FIG. 4A illustrates a schematic display module for typical installation. The display module will be placed in a housing 40 and show the display screen 14 and solar cell 22. The flexible display module will fit into the same location that current price labels do. They can be attached to the shelves by any known attachment means such as adhesive tapes, clips, screws, gondola tag and the like. FIG. 4B illustrates how the electronic display unit would look. The display can include any information required to be displayed by law on a price labeling system, such as price, unit pricing, and the like, as well as other information the store desires. For example, the label might use a UPC indicator on the label to match up the label on the shelf and the UPC label on the goods to be sure that the right shelf label is with the corrects goods.

FIG. 5 represents the microencapsulated electrophoretic display system. A store computer 32 which is programmable to manage the information about the products, trends, pricing, and the like, and holds all information about the item prices and calculates the price updates, is programmed to correlates the display ID with each item. The computer is coupled with a standard RF transceiver 30 which broadcasts the price updates to the various multiple locations to be determined for optimal coverage depending on the install situation. The information is then received by the antenna for the display module to make the appropriate changes to the display screen.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What we claim is:

1. An electronic product price display system for installation in a retail environment for displaying price and related information concerning retail consumer products price comprising:
A. at least one microencapsulated electrophoretic display label for displaying information about consumer products;
B. a power system for powering the display labels, wherein the power system comprises a photovoltaic cell coupled with a means for storing the power generated by the photovoltaic cell;
C. an antenna for receiving RF signals and transmitting them to a microcontroller;
D. a microcontroller for receiving RF communication signals and for converting the received signals into instructions to change the display labels;
E. a programmable computer module for generating instructions for said labels;
F. means for receiving said instructions from said computer and generating RF instruction signals; and
G. means for removably affixing said labels to store shelving holding the consumer products.

2. The display system of claim 1 wherein the display labels are segmented displays.

3. The display system of claim 1 wherein the display labels are dot-matrix displays.

4. The display system of claim 1 wherein the mean for storing power is a capacitor.

5. The display system of claim 1 wherein the display is a flexible display.

6. The display system of claim 1 wherein the microcontroller is a programmable micro chip embedded in a circuit board.

7. The display system of claim 1 wherein the microcontroller is a programmable micro chip embedded in a flexible circuit board.

8. The display system of claim 1 wherein the microcontroller reverts to a low power state when inactive and is activated by the receipt of a RF signal.

9. The display system of claim 1 wherein the antenna is a copper trace antenna.

10. The display system of claim 1 wherein the antenna is part of the microcontroller.

11. The display system of claim 1 wherein means for storing power is part of the microcontroller.

12. The display system of claim 1 wherein the RF communications is a passive RF communications.

13. The display system of claim 1 wherein the mean for storing power is a 100 nF capacitor.

14. The display system of claim 1 wherein the mean for storing power is a 5-1000 nF capacitor.

15. The display system of claim 1 wherein the mean for storing power is a 50-150 nF capacitor.

16. The display system of claim 1 wherein the microcontroller requires between about 1.8 volts and 12 volts.

17. An electronic product price display system for installation in a retail environment for displaying price and related information concerning retail consumer products price comprising:
A. at least one microencapsulated electrophoretic display label for displaying information about consumer products;
B. a power system for powering the display labels, wherein the power system comprises a photovoltaic cell coupled with a capacitor;
C. an antenna for receiving RF signals and transmitting them to a microcontroller;
D. a microcontroller for receiving RF communication signals and for converting the received signals into instructions to change the display labels;
E. a programmable computer module for generating instruction for said labels;
F. means for receiving said instructions from said computer and generating RF instruction signals; and
F. means for removably affixing said labels to store shelving holding the consumer products.

18. An electronic product price display for installation in a retail environment for displaying price and related information concerning retail consumer products price comprising:
A. a microencapsulated electrophoretic display label for displaying information about consumer products;
B. a power system for powering the display labels, wherein the power system comprises a photovoltaic cell coupled with a capacitor;
C. an antenna for receiving RF signals and transmitting them to microcontroller;
D. a microcontroller for receiving RF communication signals and for converting the received signals into instructions to change the display labels; and
E. means for removably affixing said display to store shelving holding consumer products.
